(19) United States
(12) Patent Application Publication
(10) Pub. No.: US 2009/0194037 A1
(43) Pub. Date: Aug. 6, 2009

(54) METHOD FOR PREVENTING PET FROM BARKING

(76) Inventor: Ho Yun SO, Seoul (KR)

Correspondence Address: HOLME ROBERTS & OWEN LLP, 1700 LINCOLN STREET, SUITE 4100, DENVER, CO, 80203, US

(21) Appl. No.: 12/395,272

(22) Filed: Feb. 27, 2009

Related U.S. Application Data
(62) Division of application No. 11/558,355, filed on Nov. 9, 2006.

(30) Foreign Application Priority Data
Sep. 11, 2006 (KR) 10-2006-0087479

(51) Int. Cl. A01K 15/04

(52) U.S. Cl. 119/718

(57) ABSTRACT

A method of controlling a device for preventing a pet from barking, comprising performing initialization and receiving pulse signals from a pulse-conversion unit for converting signals, output from a sound sensor for sensing a barking sound of a pet, into pulses; determining whether pulse signals are within a range corresponding to signals constituting an actual barking sound of the pet; determining the pulses to be the barking sound when the pulse signals correspond to the signals constituting the actual barking sound of the pet, and a total time, which is obtained by summing generation of the pulse signals is within the range of duration of signals having amplitudes more than ½ of a maximum amplitude Vcc in the barking sound, which belong to the previously measured barking signals; and generating shock voltage or vibration when the pulse signals are determined to be the actual barking sound.

### CROSS-REFERENCE TO RELATED APPLICATIONS

The present application is a divisional application of U.S. patent application Ser. No. 11/558,355, filed Nov. 9, 2006, which claims priority to South Korean Patent Application No. 10-2006-0087479, filed Mar. 27, 2006, both of which are expressly incorporated herein by reference.

### BACKGROUND OF THE INVENTION

1. Field of the Invention

The present invention relates generally to a method for preventing a pet from barking and, more particularly, to a method for preventing a pet from barking, which detects a barking sound from the pet using a sound sensor, converts the detected electrical signals into pulses, determines whether the periods of the pulses are within a range of periods of signals constituting an actual barking sound, and determines whether the detected sound is the actual barking sound depending on whether the pulses are continuously generated for a predetermined time.

2. Description of the Related Art

Modern people who live near each other must always take care to prevent their pets from being a nuisance to neighbors when keeping pets in a multi-family building, such as an apartment, or in a city where neighbors live nearby.

However, the barking sound of a pet propagates through the air to neighbors without hindrance, so that trouble with neighbors may occur. In order to resolve such a problem, a law prohibiting excessive noise may be enacted, or various methods, such as a method of training pets not to bark, can be used.

Various technologies for preventing pets from barking have been developed. A representative of them is a device for preventing a pet from barking, which detects the barking sound of the pet, provides a warning through sound or vibration, and then applies an electric shock when the pet continuously barks in spite of the warning, which is disclosed in U.S. Pat. No. 5,927,233.

The conventional device for preventing a pet from barking, as shown in FIG. 1, includes a vibration sensor 3 attached to the collar of a pet dog 1 to detect vibration generated in the neck of the pet dog, a microphone 4 configured to sample ambient sound, amplifiers 5 and 6 configured to amplify the outputs of the vibration sensor 3 and the microphone 4, a central processing device 7 configured to convert signals, sampled by the microphone 4, into vectors and compare the vectors with the vectors of barking samples previously stored in the memory 8 and to output a barking control signal when they match each other, and a stimulus output unit 9 configured to receive the barking control signal and to output a stimulus to the pet dog.

The conventional device for preventing a pet from barking detects vibration generated in the neck of the pet dog and then activates the microphone, therefore there are problems in that the vibration sensor operates correctly only when it accurately contacts the vocal cords of the pet dog, in that the vibration sensor operates and then the microphone operates when the collar of the pet dog is scratched or stimulated, thereby causing unnecessary power consumption, and in that the vibration sensor, the microphone and the two amplifiers for operating two devices are required, thereby causing the overall size of the device to unnecessarily increase.

### SUMMARY OF THE INVENTION

Accordingly, the present invention has been made keeping in mind the above problems occurring in the prior art, and an object of the present invention is to provide a method for preventing a pet from barking or crying.

Another object of the present invention is to provide a method for preventing a pet from barking, which detects the barking sound of the pet and examines the barking sound based on the frequency range of the period range and duration of the barking sound, and then prevents the pet from barking.

In order to accomplish the above object, the present invention provides a method for preventing a pet from barking, including a sound sensor for converting a barking sound of a pet into electric signals; a pulse-conversion unit for converting signals, output from the sound sensor, into pulses; a control unit for determining the pulses to be the barking sound when periods of the pulse signals output from the pulse conversion unit are within a range corresponding to periods of signals constituting an actual barking sound of the pet and the pulse signals within the range are output for the duration of signals having amplitudes more than ½ of a maximum amplitude Vcc in the barking sound, which belong to previously measured signals, and outputting a barking prevention signal; a shock voltage generation unit for receiving the barking prevention signal from the control unit and outputting shock voltage; and a vibration generation unit for receiving the barking prevention signal from the control unit and outputting vibration.

The pulse conversion unit includes an amplifier for amplifying the electric signals output from the sound sensor, and an inverter U₁ for converting the electric signals, output from a transistor, into pulses having inverted phases on the basis of a reference voltage.

A method of controlling a device for preventing a pet from barking, includes the steps of performing initialization and receiving pulse signals from a pulse-conversion unit for converting signals, output from a sound sensor for sensing a barking sound of a pet, into pulses; determining whether periods of pulse signals are within a range corresponding to periods of signals constituting an actual barking sound of the pet; determining the pulses to be the barking sound when the periods of the pulse signals correspond to the periods of signals constituting the actual barking sound of the pet, and a total time, which is obtained by summing generation of the pulse signals, is within the range of duration of signals having amplitudes more than ½ of a maximum amplitude Vcc in the barking sound, which belong to the previously measured barking signals; and generating shock voltage or vibration when the pulse signals are determined to be the actual barking sound.

The periods of signals constituting the actual barking sound of the pet are within a range of 0.33˜10 ms.

The duration of signals having amplitudes more than ½ of a maximum amplitude Vcc of the signals in the barking sound is within a range of 50˜150 milliseconds.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a conventional device and method for preventing a pet from barking, which operate a microphone using vibration generated in the neck of a pet dog, and identify the barking sound of the pet dog;

FIG. 2 is a block diagram illustrating the construction of a device for preventing a pet from barking according to the present invention;

FIG. 3 is a diagram illustrating electric signals that are obtained by detecting barking sound, generated when the pet dog barks, using a sound sensor, amplifying the barking sound using an amplifier and then measuring the barking sound using a sound meter;

FIG. 4 is a circuit diagram illustrating the construction of the pulse conversion unit of the device for preventing a pet from barking according to the present invention;

FIG. 5(a) is a diagram illustrating electric signals of a barking sound output from the amplification unit of the device for preventing a pet from barking according to the present invention;

FIG. 5(b) is a diagram illustrating the electric signals of a barking sound output from the inverter of the device for preventing a pet from barking according to the present invention; and

FIG. 6 is a diagram illustrating a method of identifying the barking sound of a pet dog from signals detected by the sound sensor according to the present invention.

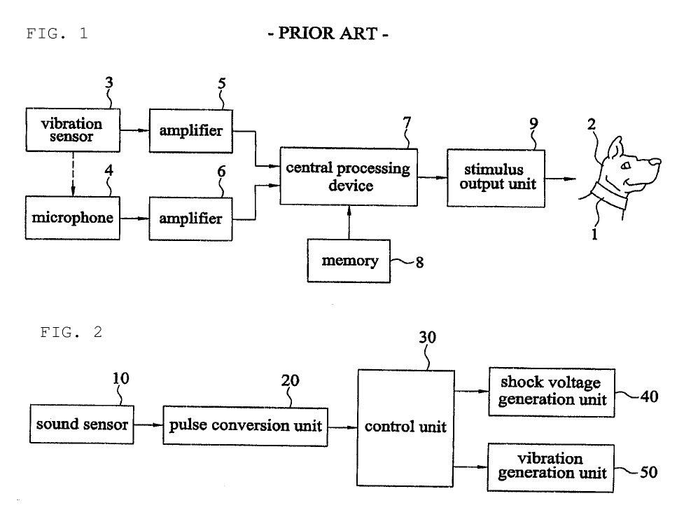

### DESCRIPTION OF THE PREFERRED EMBODIMENTS

Reference now should be made to the drawings, in which the same reference numerals are used throughout the different drawings to designate the same or similar components.

FIG. 2 is a block diagram illustrating the construction of a device for preventing a pet from barking according to the present invention.

The device includes a sound sensor 10 for converting the barking sound of a pet into electric signals; a pulse-conversion unit 20 for converting signals, output from the sound sensor 10, into pulses; a control unit 30 for determining the pulses to be an actual barking sound when the periods of the pulse signals output from the pulse conversion unit 20 are within a range corresponding to the periods of signals constituting an actual barking sound of a pet and the pulse signals within the range are output for the duration of signals having amplitudes more than ½ of a maximum amplitude Vcc in the barking sound, which belong to the previously measured barking signals, and outputting a barking prevention signal; a shock voltage generation unit 40 for receiving the barking prevention signal and outputting shock voltage; and a vibration generation unit 50 for receiving the barking prevention signal from the control unit 30 and outputting vibration.

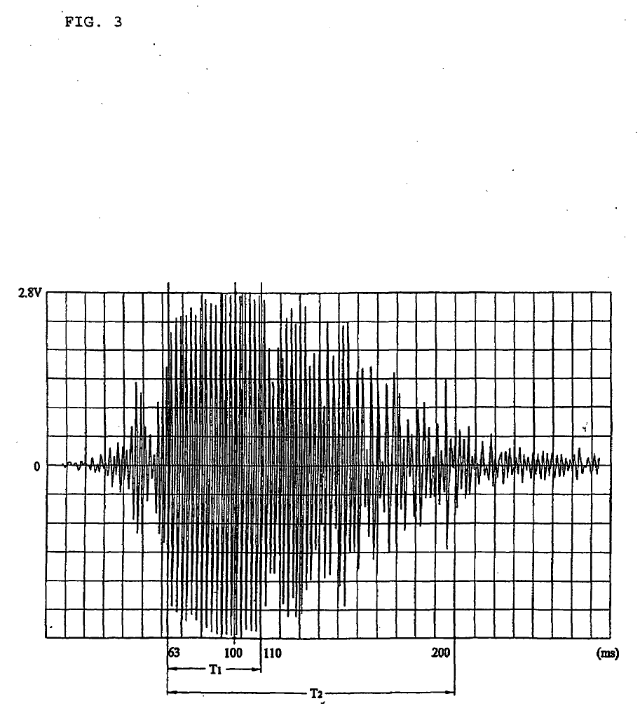

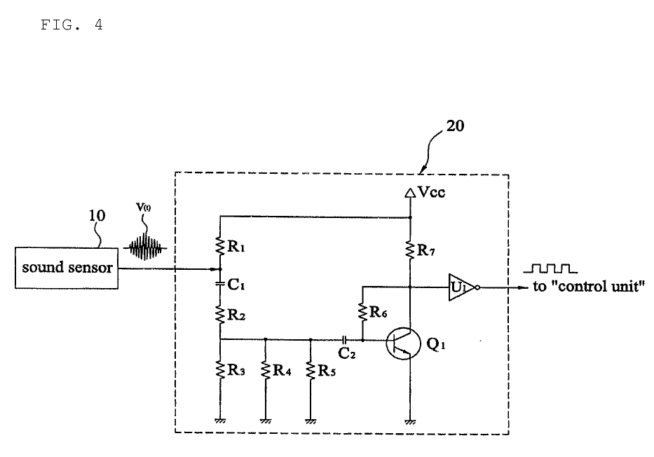

The sound sensor 10 may be formed of, for example, a microphone or a piezoelectric element, and converts the barking sound of a pet into electric signals. In the case of the barking sound of a pet, when the electric signals of the sound occurring when a pet dog barks once are measured using a sound meter, a sound having a frequency range of 100˜3,000 Hz continues for about 300 ms, as shown in FIG. 3.

In the electric signals of the barking sound shown in FIG. 3, sine wave signals, which are within a frequency range of 100˜3,000 Hz and have different amplitudes, are superimposed on each other and are continuously generated for about 300 ms when a pet dog barks once.

However, of the signals generated for 300 milliseconds, signals having significant amplitudes (for example, more than ½ of a maximum amplitude Vcc), which can be determined to be a barking sound, are continuously generated for 50 ms (T₁) ranging from about 63 to 110 ms along a time axis in the example of FIG. 3.

Furthermore, as a result of the analysis of barking sounds from various pet dogs, signals, the amplitudes of which are greater than ½ of a maximum amplitude Vcc, are generated for 150 ms (T₂) at its maximum. Therefore, when sine wave signals, the frequencies of which are within a frequency range of 100˜3,000 Hz and the amplitudes of which are greater than ½ of a maximum amplitude Vcc, are generated within a time range of 50˜150 milliseconds, a sound having the sine wave signals can be determined to the barking sound of a dog pet.

As illustrated in FIG. 3, the barking sound of the pet dog has superimposed signals having different frequencies, but can be expressed as a plurality of sine wave signals which vibrate at various amplitudes with respect to the X axis. The plurality of sine wave signals are within a frequency range of 100˜3,000 Hz and have various amplitudes, and the periods of the signals are the inverses of frequencies, so the sine waves have periods ranging from 0.33 to 10 ms.

Therefore, the sine wave signals have been converted into pulses, the periods of the pulses have been calculated, and only signals, which are continuously generated for 50˜150 ms within a range of 0.33˜10 ms, are identified as the barking sound of a pet dog. The duration time may be changed depending on the breed of a dog and, if the duration time is changed according to the kind of a pet, a barking sound can be more accurately identified.

FIG. 4 is a diagram illustrating an embodiment of the construction of a pulse conversion unit according to the present invention.

The pulse conversion unit includes a transistor Q₁ for amplifying electric signals output from the sound sensor 10, bias resistors R₁, R₂, R₃, R₄, R₅, R₆ and R₇ for setting bias voltage between the base and emitter of the transistor Q₁ or between the collector and emitter of the transistor Q₁; capacitors C₁ and C₂ for blocking high frequency noise; and an inverter U₁ for converting the electric signals, output from the transistor Q₁, into pulses having inverted phases on the basis of a specific voltage (for example, 1 V).

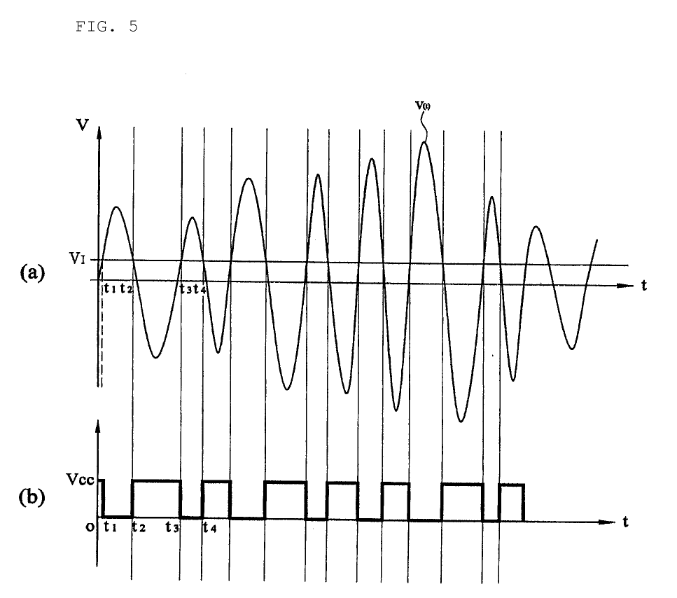

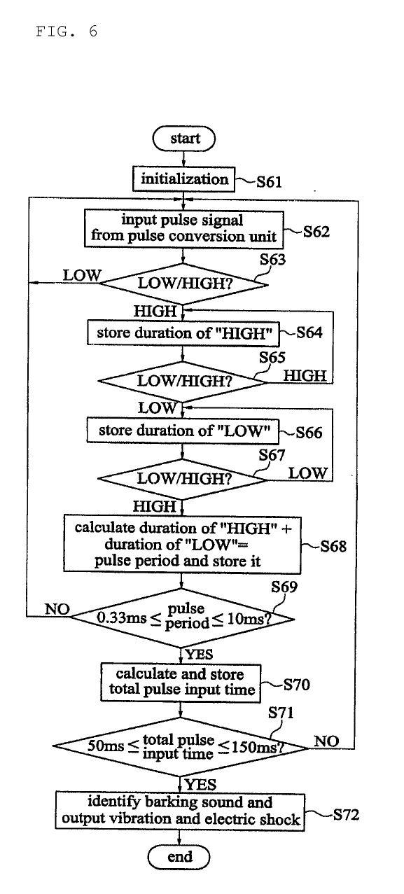

FIG. 5(a) illustrates the electric signals of a barking sound output from the transistor amplifier of the device for preventing a pet from barking according to the present invention.

The electric signals v(t) of the barking sound, which are output from the sound sensor 10 and are then output from the collector of the transistor Q₁ of the pulse conversion unit 20, can be displayed in the form of smooth sine wave signals, as illustrated in FIG. 5(a), when a time unit is reduced (for example, a graduation corresponds to 1 ms).

When the value of electric signals v(t), having been amplified and output by the transistor Q₁, is greater than voltage V₁ (for example, a value equal to or higher than 0.9 V), which can cause the inverter U₁ to operate, at time point t₁ in FIG. 5, the inverter U₁ outputs a signal of 0 V in a range from time point t₁ to time point t₂ in FIG. 5 (b).

The output voltage of the inverter U₁ is Vcc in a range from time point t₂ to time point t₃ in FIG. 5(a), in which the value of the electric signals v(t) is less than voltage V₁ which can cause the inverter U₁ to operate.

As the value of v(t) varies, the inverter U₁ alternately outputs 0 V and Vcc. For example, the barking sound of a pet dog is within a range of 100-3,000 Hz. Accordingly, when the electric signals (see FIG. 3) are converted into pulses, the periods of pulse signals are within a range of 0.33˜10 ms, which is the inverse of the range of frequencies.

Furthermore, since signals having voltage amplitudes (for example, ½ Vcc), which are large enough to be identified as amplitudes related to an actual barking sound, are continuously generated, as shown in FIG. 3, the pulse signals, into which the signals are converted, are continuously generated for 50-150 ms.

The pulses output from the inverter Ui of the pulse conversion unit are input to the control unit 20, and the control unit 30 identifies them as a barking sound depending on whether the periods of the input pulse signals are within a range of 0.33˜10 ms and the duration time thereof is within 50˜1.50 ms.

FIG. 6 is a flowchart illustrating a method of identifying a barking sound based on signals detected by the sound sensor according to the present invention.

At step S61, initialization is performed, and then pulse signal (for example, the pulse signal shown in FIG. 5 (b)) is received from the pulse conversion unit 20 at step S62. Whether the input pulse signal is “HIGH (Vcc)” is determined at step S63, and, if the pulse signal is not “HIGH (Vcc)” (for example, for the time ranging from t₁ to t₂), the process returns to step S62 and then repeats the step.

At step S63, when the input pulse signal is “HIGH (Vcc)” (for example, at time point t₂ in FIG. 5 (b)), the duration of a “HIGH (Vcc)” state is calculated and is then stored at step S64. Whether the input pulse signal is “LOW/HIGH (Vcc) is determined again at step S65, and, if the pulse is still “HIGH (Vcc)”, the process returns to step S64, at which the duration (for example, for the time ranging from t₂ to t₃ in FIG. 5 (b)) for “HIGH (Vcc)” is calculated and then stored.

At step S65, when the input pulse signal enters a “LOW” state (for example, at time point t₃ in FIG. 5 (b)), it means that the “HIGH (Vcc)” state of the pulse is terminated and the “LOW” state begins. Accordingly, the duration of a “LOW” state is calculated and then stored at step S66, and whether the input pulse signal is “LOW/HIGH (Vcc)” is determined in order to determine whether the “LOW” state is terminated again at step S67. If the pulse signal is still maintained in the “LOW” state, the process returns to step S66, at which the step of storing the duration of the “LOW” state (for example, the time ranging from t₃ to t₄ in FIG. 5 (b)) is repeatedly performed.

If the input pulse signal is determined to be “HIGH (Vcc)” as a result of the determination at step S67 (for example, at time point t, in FIG. 5(b)), it means that one pulse is completed. Therefore, the duration of a “HIGH (Vcc)” state and the duration of a “LOW” state are calculated and the sum thereof is calculated as the period of the “pulse” at step S68. Thereafter, whether the calculated period of the pulse is within a range of 0.33˜10 ms is determined at step S69.

If the calculated period of the pulse is not within the range of 0.33˜10 ms, the input pulse signal including the pulse is not a sound included in the frequency range (for example, 100˜3,000 Hz) of the barking sound of a pet dog, therefore the process returns to step S62, and the steps following step S62 (for example, the step of measuring the periods of second or subsequent pulses of FIG. 5(b)) are repeated.

If the calculated period of the pulse is within the range of 0.33˜10 ms, the input pulse signal including the pulse is a sound included in the frequency range (for example, 100-3,000 Hz) of the barking sound of a pet dog, therefore the total input time of pulses that are determined to be a barking sound is calculated and stored at step S50, and whether the total input time of the pulses is within a range of 50˜150 ms is then determined at step S71.

If the total input time of the pulses is not within the range of 50˜150 ms, it means that one barking sound is not terminated yet, therefore the process returns to step S62. Thereafter, the period of a pulse signal input from the pulse conversion unit 20 is calculated, and whether the pulse signal is within the frequency range (for example, 100˜3,000 Hz) of the barking sound of a pet is determined, therefore the step of identifying the barking sound is repeatedly performed on signals having amplitudes that can be determined to be those of a barking sound.

When the total input time of pulses is within the range of 50-150 ms, the pulses are determined to be pulses constituting an actual barking sound, and thus a signal for generating vibration or an electric shock is output at step S72, and then the process is terminated.

As described above, according to the present invention, the barking sound of a pet detected by the sound sensor is converted into pluses and the barking sound is identified based on the periods and duration of the pulses, so that the barking sound can be accurately identified without contacting the vocal cords of the pet dog, and the size of the device can be reduced through the use of a single sensor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1.-2. (canceled)

3. A method of controlling a device for preventing a pet from barking, comprising the steps of:
performing initialization and receiving pulse signals from a pulse-conversion unit for converting signals, output from a sound sensor for sensing a barking sound of a pet, into pulses;
determining whether periods of pulse signals are within a range corresponding to periods of signals constituting an actual barking sound of the pet;
determining the pulses to be the barking sound when the periods of the pulse signals correspond to the periods of signals constituting the actual barking sound of the pet, and a total time, which is obtained by summing generation of the pulse signals, is within a range 50˜150 ms, which belong to the previously measured barking signals; and
generating shock voltage or vibration when the pulse signals are determined to be the actual barking sound.

4. The method as set forth in claim 3, wherein periods of signals constituting the actual barking sound of the pet are within a range of 0.33-10 ms.

5. (canceled)
